(19) United States
(12) Patent Application Publication
(10) Pub. No.: US 2017/0284326 A1
(43) Pub. Date: Oct. 5, 2017

(54) ENGINE CONTROL DEVICE AND ENGINE

(71) Applicant: Yanmar Co., Ltd., Osaka-shi, Osaka (JP)

(72) Inventors: Daiki HORI, Osaka-shi, Osaka (JP); Hidehiro YUKI, Osaka-shi, Osaka (JP)

(73) Assignee: Yanmar Co., Ltd., Osaka-shi, Osaka (JP)

(21) Appl. No.: 15/316,481

(22) PCT Filed: Jun. 2, 2015
(86) PCT No.: PCT/JP2015/002787

§ 371 Date: Jun. 14, 2017

(30) Foreign Application Priority Data
Jun. 6, 2014 (JP) 2014-117502
Dec. 2, 2014 (JP) 2014-243861

(51) Int. Cl. F02D 41/10; F02D 31/00; F02D 41/26

(52) U.S. Cl. CPC F02D 41/107; F02D 41/26; F02D 31/001; F02D 2200/101

(57) ABSTRACT

An ECU of an engine performs control to keep a constant engine speed when a load factor is equal to or less than a predetermined value, and to reduce and correct the engine speed in accordance with an increase in the load factor when the load factor exceeds the predetermined value. The ECU is provided with a reference droop control correction amount calculation unit (36), a correction amount adjustment map storage unit, and a post-adjustment correction amount calculation unit (38). The reference droop control correction amount calculation unit (36) obtains an engine speed reference reduction correction amount NBD that is increased at a constant rate in accordance with the increase in the load factor from the predetermined value. The correction amount adjustment map storage unit stores, as a correction amount adjustment map (111), a subtraction factor that varies depending on the load factor. On the basis of the engine speed reference reduction correction amount NBD and the subtraction factor, the post-adjustment correction amount calculation unit (38) calculates an engine speed reduction correction amount ND as an amount by which the engine speed is reduced and corrected in accordance with the increase in the load factor when the load factor exceeds the predetermined value.

### TECHNICAL FIELD

The present invention mainly relates to an engine control unit that controls an engine in accordance with a predetermined engine speed regulation characteristic.

### BACKGROUND ART

An electronic governor mechanism as an engine control unit has been conventionally known. The electronic governor mechanism is a control device that electrically controls the amount of fuel injection of an engine so as to stabilize an engine speed in a target engine speed.

An isochronous control and a droop control are well-known controls as control means of the amount of fuel injection in the electronic governor mechanism. The isochronous control is, when the engine speed is reduced by applying a load to the engine, to correct the engine speed to the original engine speed by recovering the reduced amount of engine speed and to keep a constant engine speed. The droop control is, when the load is applied to the engine, to increase the amount of fuel injection while reducing the engine speed depending on the degree of load.

Patent Document 1 discloses an engine control unit that performs a simulated isochronous control in which the isochronous control is combined with the droop control. The control performed in Patent Document 1 discloses that, in the isochronous control, the engine speed is corrected by reducing the engine speed in a constant rate along with an increasing in an output exceeded from a predetermined engine output (rack position). In Patent Document 1, the simulated isochronous control is referred to as a virtual droop control.

The engine control unit of Patent Document 1 has a configuration in which the output is correct by decreasing the engine speed in accordance with the engine output increased from a predetermined output when the engine output is increased over the predetermined output. Specifically, the engine speed correction amount at a time of the output of the engine is calculated by a predetermined rate for the maximum output of the engine (virtual droop margin load factor RLvd) and a reduction value (virtual droop down engine speed Nvd) of the engine speed in the maximum output of the engine. The virtual droop margin load factor RLvd and the virtual droop down engine speed Nvd are preset for each target engine speed, and stored in a memory (storage unit).

Patent Document 2 discloses this kind of engine control unit. The engine control unit of Patent Document 2 includes an electric fuel injector that controls the amount of fuel injection, an input mean that indicates a reference target engine speed of the engine, a load computation mean that calculates a load torque of a hydraulic pump driven by the engine, and a control mean that controls the electric fuel injector, using the preset engine speed and regulation characteristic in accordance with the engine load torque, by calculating a fuel injection command value based on the reference target engine speed indicated by the input mean and the load torque calculated by the load computation mean. The control mean sets the regulation characteristic as a plurality of characteristics that correspond to each of a high speed range, a medium speed range, and an idle range of the engine speed. The control mean selects one of these characteristics in accordance with the reference target engine speed indicated by the input mean, and then calculates the fuel injection command based on the selected characteristic and the load torque calculated by the load computation mean.

Accordingly, in Patent Document 2, the electric fuel injector can be controlled by the regulation characteristic in accordance with the engine load torque for the input reference target engine speed. Accordingly, the engine speed can be appropriately controlled without considering the magnitude of the engine load torque and the range of engine speed.

### PRIOR-ART DOCUMENTS

### Patent Documents

PATENT DOCUMENT 1: Japanese Patent Application Laid-Open No. 2009-36179

PATENT DOCUMENT 2: Japanese Patent No. 4127771

### SUMMARY

### Problems to be Solved By the Invention

An engine is generalized in recent years, in particular, in a diesel engine, because of its high versatility, one type of engine is applied for various type of machineries having different applications or load characteristics such as marine vessel, construction machinery, agricultural machinery and the like.

For the diversification of the applications, the correction amount of engine speed in a virtual droop control (reference droop control) disclosed in Patent Document 1 is calculated by multiplying the amount of output increased from the predetermined engine output by a constant rate, and therefore a droop line is a downward-sloping straight line. Thus, some applications may involve an insufficient power, and other applications may involve too fast load responsivity. In this respect, there is a room for improvement.

In Patent Document 2, an appropriate regulation characteristic is selected for the inputted reference target engine speed and then the electric fuel injector is controlled based on the load torque calculated by using the selected regulation characteristic. A polygonal line as a whole, in which the gradient varies depending on the magnitude of engine load torque and the gradient is larger as the engine load torque is increasing, is proposed as the regulation characteristic. However, similarly to Patent Document 1, Patent Document 2 also has the problem of the insufficient output or the sensitive responsivity for the variation of load depending on the applications or load characteristics. Therefore, measures for solving the problem are desired.

The present invention is made in view of the circumstances described above, and an object of the present invention is to flexibly match a regulation characteristic of an engine in accordance with applications or load characteristics.

### Means for Solving the Problems and Effects Thereof

The problem to be solved by the present invention is as described above, and next, means for solving the problem and effects thereof will be described.

In an aspect of the present invention, an engine control unit described below is provided. That is, the engine control unit performs an engine control that keeps a constant engine speed regardless of variation of load when a load is equal to or less than a predetermined load, and corrects the engine speed by decreasing along with an increase in load when the load exceeds the predetermined load. The engine control unit includes an engine speed reference reduction correction amount acquisition unit, a correction amount adjustment parameter storage unit, and an engine speed reduction correction amount calculation unit. The engine speed reference reduction correction amount acquisition unit acquires an engine speed reference reduction correction amount that is increasing at a constant factor in accordance with the amount of increased load from the predetermined load. The correction amount adjustment parameter storage unit stores a correction amount adjustment parameter that is changed in accordance with the load. The engine speed reduction correction amount calculation unit calculates an engine speed reduction correction amount that is the amount of correction by decreasing the engine speed along with an increase in load from the exceeded load is calculated based on the engine speed reference reduction correction amount and the correction amount adjustment parameter.

That is, merely performing the control that is defined as the virtual droop control in Patent Document 1 may lead an insufficient output or too fast load responsivity by outputting, depending on the applications and load characteristics of engine. Here, by using the above-described control as a reference, the correction amount of engine speed is adjusted depending on the correction amount adjustment parameter and the engine speed reduction correction amount calculation unit. This allows regulation characteristics of the engine to be flexibly matched depending on applications, load characteristics and the like.

In the engine control unit, preferably, the engine speed reduction correction amount calculation unit adjusts the engine speed reduction correction amount so as to be larger than the engine speed reference reduction correction amount or smaller than that based on the correction amount adjustment parameter.

Accordingly, the reduction of the engine speed is suppressed if it is assumed that a reference engine speed correction control is insufficient. The engine speed can be adjusted so as to promote its reduction if it is assumed that the reference engine speed correction control leads to too fast load responsivity. Therefore, the regulation characteristics of the engine can be easily and flexibly matched with the wide range of applications and the like.

In the engine control unit, preferably, the engine speed reduction correction amount calculation unit calculates the engine speed reduction correction amount by multiplying a ratio based on the correction amount adjustment parameter by the engine speed reference reduction correction amount.

Accordingly, since the correction amount is adjusted by calculating the ratio, the engine speed reduction correction amount can be adjusted in response to wide situations with a simple calculation.

Preferably, the engine control unit is configured as follows. That is, the correction amount adjustment parameter storage unit stores the correction amount adjustment parameter in a tabular format. The engine speed reduction correction amount calculation unit is configured to obtain the correction amount adjustment parameter depending on the load by interpolation calculation between values stored in the table.

This can appropriately calculate the subtraction factor depending on the load with a small storage capacity for storing the correction amount adjustment parameter.

Preferably, the engine control unit is configured as follows. That is, the correction amount adjustment parameter storage unit stores a plurality of kinds of correction amount adjustment parameters. The engine speed reduction correction amount calculation unit calculates the engine speed reduction correction amount depending on one correction amount adjustment parameter selected from the plurality of kinds of correction amount adjustment parameters prior to a start of the engine.

Accordingly, the regulation characteristics of the engine can be easily and flexibly matched with the applications, load characteristics and the like.

In other aspect of the present invention, an engine including the engine control unit is provided.

This can provide the engine in which the regulation characteristics can be easily matched with the applications, load characteristics and the like.

### BRIEF DESCRIPTION OF THE DRAWINGS

FIG. 1. A plan view of an engine according to one embodiment of the present invention.

FIG. 2. An explanatory diagram schematically showing a flow of air intake and air discharge.

FIG. 3. An explanatory diagram schematically showing a configuration for injecting fuel to combustion chambers.

FIG. 4. A block diagram of an engine control.

FIG. 5. A diagram showing a regulation characteristic of a reference droop control.

FIG. 6. A diagram showing a regulation characteristic in a first example of a post-adjustment droop control.

FIG. 7. A diagram showing a correction amount adjustment map stored in the first example.

FIG. 8. A diagram showing a regulation characteristic in a second example of the post-adjustment droop control.

FIG. 9. A diagram showing a correction amount adjustment map stored in the second example.

FIG. 10. A signal flow diagram of a droop control in this embodiment.

FIG. 11. A diagram showing other examples for adjusting the droop control.

FIG. 12. A Torque diagram showing an isochronous control, a droop control, and a reference droop control respectively.

FIG. 13. A flowchart showing a control of abnormality of fuel.

### EMBODIMENT FOR CARRYING OUT THE INVENTION

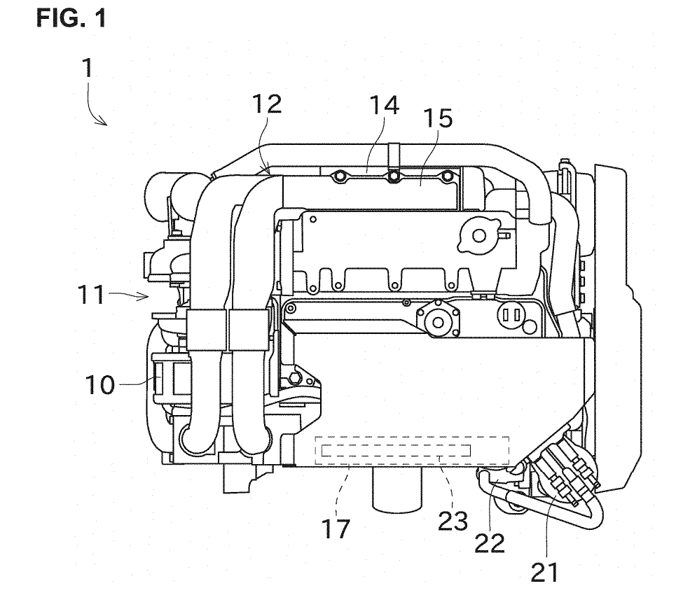

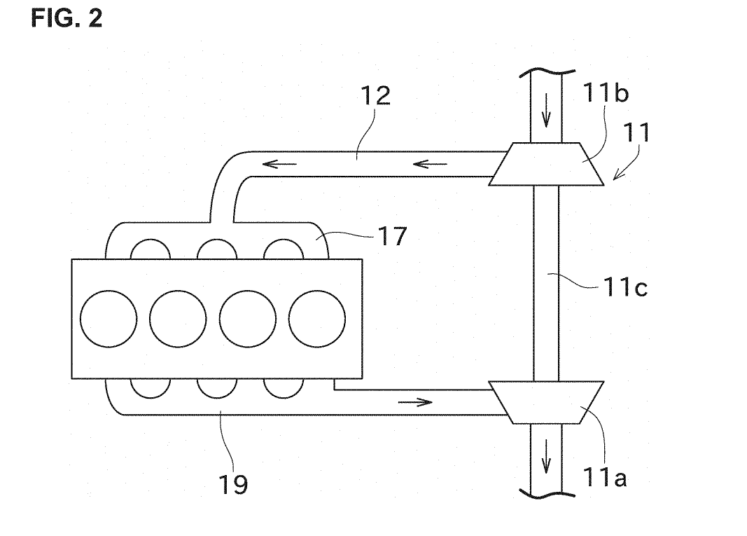

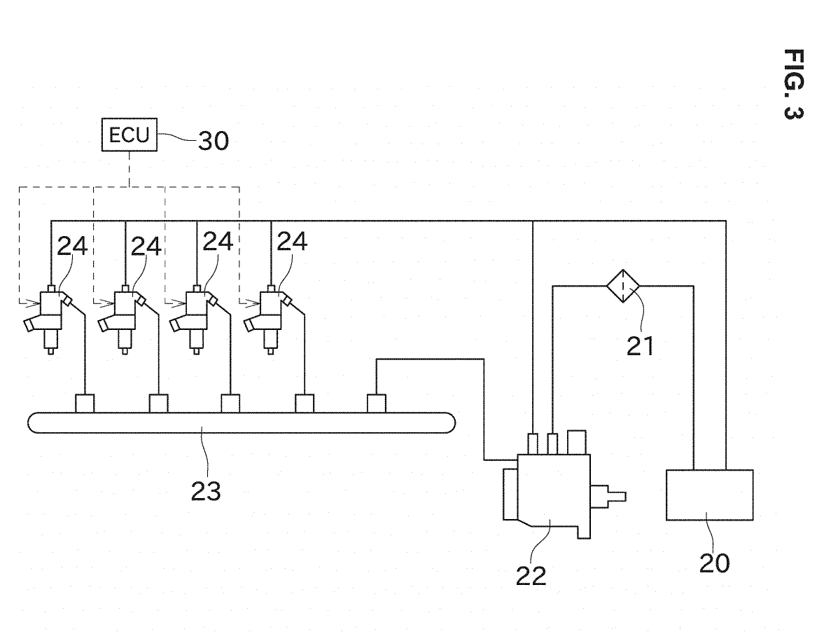

Next, an embodiment of the present invention will be described with reference to drawings. An engine 1 of this embodiment is a diesel engine having a common-rail fuel injector. The engine 1 is configured as an inboard engine for a marine vessel. Firstly, a configuration of the engine 1 will be simply described. FIG. 1 is a plan view of the engine 1 according to one embodiment of the present invention. FIG. 2 is an explanatory diagram schematically showing a flow of air intake and air discharge. FIG. 3 is an explanatory diagram schematically showing a configuration for injecting a fuel to combustion chambers.

As shown in FIG. 1, the engine 1 includes an intake unit 10, a turbocharger 11, an intake pipe 12, an intercooler 14, a fresh water cooler 15, and an intake manifold 17.

The intake unit 10 intakes outside air. An air cleaner for removing dust and the like included in an intake air is arranged within the intake unit 10. The turbocharger 11 includes a turbine wheel 11a and a compressor wheel 11b as shown in FIG. 2. The turbine wheel 11a is configured to rotate by using an exhaust gas. The compressor wheel 11b is connected to a shaft 11c to which the turbine wheel 11a is also connected, and configured to rotate along with rotation of the turbine wheel 11a. As such, rotation of the compressor wheel 11b enables to compress air and to forcibly intake air.

The intake unit 10 and the turbocharger 11 are connected with the intercooler 14 by the intake pipe 12. The air flowed through the intake pipe 12 is cooled by the intercooler 14. The intercooler 14 cools the air that is sucked by the intake unit 10 and the turbocharger 11 by means of heat exchange to water (in this embodiment, seawater) taken from outside vessel. The seawater used for heat exchange in the intercooler 14 is further used for heat exchange with the cooling water in the fresh water cooler 15, and then discharged to the outside of the vessel.

The air cooled by the intercooler 14 is supplied to the intake manifold 17 via the intake pipe 12. The intake manifold 17 distributes the air in accordance with the number of cylinders of the engine 1, and then provides to combustion chambers. In the combustion chambers, the air that is supplied from the intake manifold 17 is compressed, and then the fuel is injected. Accordingly, the combustion can be generated in the combustion chambers, which enables pistons to be driven up and down. The power generated as above is transmitted to a predetermined equipment (a screw for propulsion) via a crankshaft or the like.

The exhaust gas generated in the combustion chambers is collected by an exhaust manifold 19 shown in FIG. 2, passed through the turbine wheel 11a of the turbocharger 11, and then discharged.

Next, in the engine 1, a configuration for supplying and injecting the fuel will be described. The engine 1 includes a fuel tank 20, a fuel filter 21, a fuel pump 22, a common rail 23 and injectors 24 as shown in FIG. 3. The engine 1 includes an ECU (engine control unit) 30 that controls each parts in the engine 1 based on a pre-set program, information and the like obtained by the various type of sensors which will be described later.

The fuel pump 22 sucks the fuel accumulated in the fuel tank 20. The fuel sucked by the fuel pump 22 passes through the fuel filter 21, and thereby dust and dirt included in the fuel are removed. The fuel pump 22 supplies the sucked fuel to the common rail 23. The common rail 23 stores the fuel supplied by the fuel pump 22 under high pressure, and then distributes the fuel and supplies to the plurality of injectors 24.

Each of the injectors 24 is attached to an upper portion of each of the cylinders included in the engine 1. Each of the injectors 24 includes a fuel injection valve (an injector solenoid valve which will be described later) for injecting the fuel to the combustion chamber. The injector solenoid valve injects the fuel to the combustion chamber by opening and closing at a timing in accordance with the instructions by the ECU 30. This configuration can achieve adjustment of the output, clean of the exhaust gas, suppression of a noise and the like.

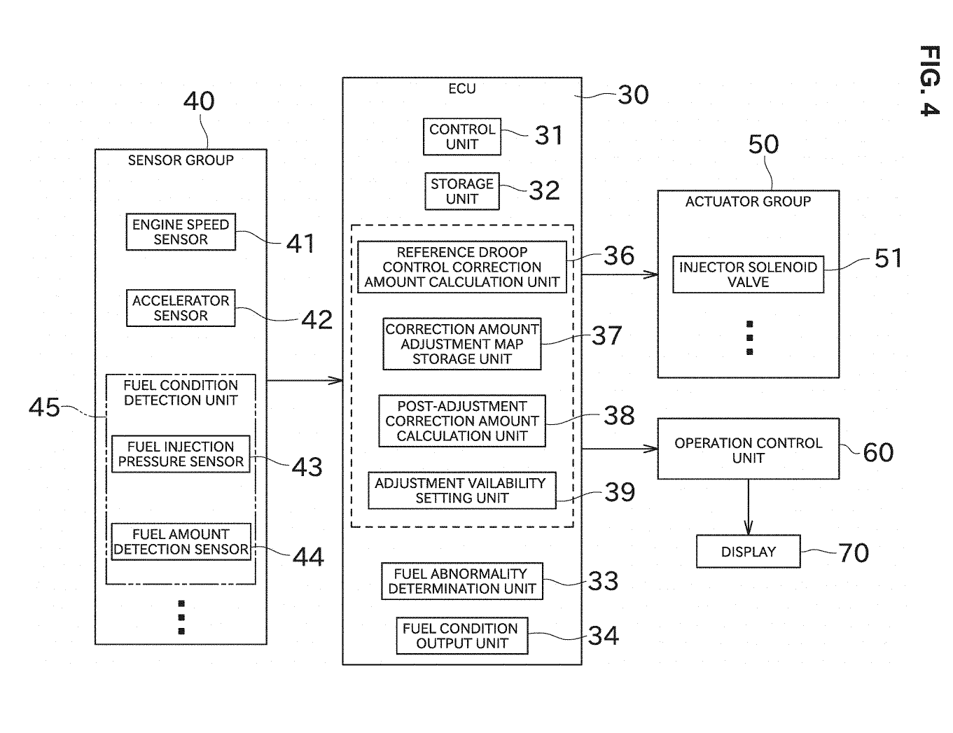

Next, the control performed by the ECU 30 for the output of the engine 1 will be described with reference to FIG. 4. FIG. 4 is a block diagram of an engine control.

The ECU 30 includes a control unit 31, a storage unit 32, a fuel abnormality determination unit 33 and a fuel condition output unit 34. The ECU 30 configured as a microcomputer, as shown in FIG. 4, sends a control command to the various actuators in an actuator group 50 based on the information from the various sensors in a sensor group 40, and controls the various parameters (for example, the amount of fuel injection, the amount of intake air, the reduction amount of exhaust gas and the like) for operating the engine 1. In addition, the ECU 30 can output the various data toward an operation control unit 60 that controls an operation part (not shown) in the marine vessel. The operation control unit 60 can display the various information such as a remaining amount of the fuel for a display (display part) 70 provided at a driving part (for example, a cockpit) in the marine vessel.

The control unit 31 includes a CPU and the like (not shown). The control unit 31 sends an appropriate control command to the actuator group 50 based on the information from the sensor group 40 and the information of actuation of the engine 1 stored in the storage unit 32, and thereby controls the output of the engine.

The storage unit 32 includes a ROM, a RAM and the like (not shown). The storage unit 32 stores the various programs and a plurality of control information (control map) that is preset for the control of the engine 1. The control map shows, for example, a fuel injection timing corresponding to the characteristic of the output of the engine, the intake amount of air, the reduction amount of exhaust gas and the like. In the storage unit 32, a correction amount map (a correction table) showing the correction amount of speed of the engine 1 depending on the remaining amount of fuel is also stored as one of the above-described control maps. The correction amount map is used in an after-mentioned reference droop control performed in accordance with the detection of fuel abnormality.

In the ECU 30, the hardware such as the above-described CPU, ROM, RAM and the like collaborates and works with the program stored in the storage unit 32, which allows the ECU 30 to be functioned as a reference droop control correction amount calculation unit (an engine speed reference reduction correction amount acquisition unit) 36, a correction amount adjustment map storage unit (a correction amount adjustment parameter storage unit) 37, post-adjustment correction amount calculation unit (an engine speed reduction correction amount calculation unit) 38, and an adjustment availability setting unit 39.

The fuel abnormality determination unit 33 determines whether or not the abnormality of fuel (specifically, fuel leakage) occurs, based on the sensor detection result of the fuel state.

The fuel condition output unit 34 outputs in real time the fuel abnormality determined by the fuel abnormality determination unit 33 and the information such as the fuel amount detected by the sensor that is provided in the fuel tank 20, toward the operation control unit 60. The operation control unit 60, based on that information, displays a status of the fuel abnormality and the like on the display 70, and thereby a user can accurately recognize the current status.

The sensor group 40 includes an engine speed sensor 41 that measures the engine speed of the engine 1, an accelerator sensor 42 that detects the depressed amount of an accelerator (a setting position of a target engine speed), a fuel injection pressure sensor 43 that detects the pressure of the common rail 23, and the like. Each of the sensors in the sensor group 40 detects the various information for controlling the engine 1, and then outputs the detected result to the ECU 30.

The actuator group 50 allows each parts of the engine 1 to be operated. Specifically, the actuator group 50 includes injector solenoid valves 51 and the like provided in the injectors 24 for injecting the fuel.

Next, the control of the engine 1 performed by the ECU 30 of this embodiment will be described. This control is the control in which a speed control referred to as the virtual droop control in Patent Document 1 is appropriately changed. Firstly, the basic control (which may be referred to as the reference droop control in this embodiment) will be described.

The reference droop control is referred to as the virtual droop control in Patent Document 1. Patent Document 1 describes that the virtual droop control is the control in which an isochronous control and a droop control are combined. Specifically, a constant engine speed is kept in a range where the engine output is lower than a predetermined engine output defined by the amount of virtual droop margin. When the engine output is higher than the predetermined engine output defined by the amount of virtual droop margin, the engine speed is corrected so as to reduce in a constant rate along with an increase in the engine output.

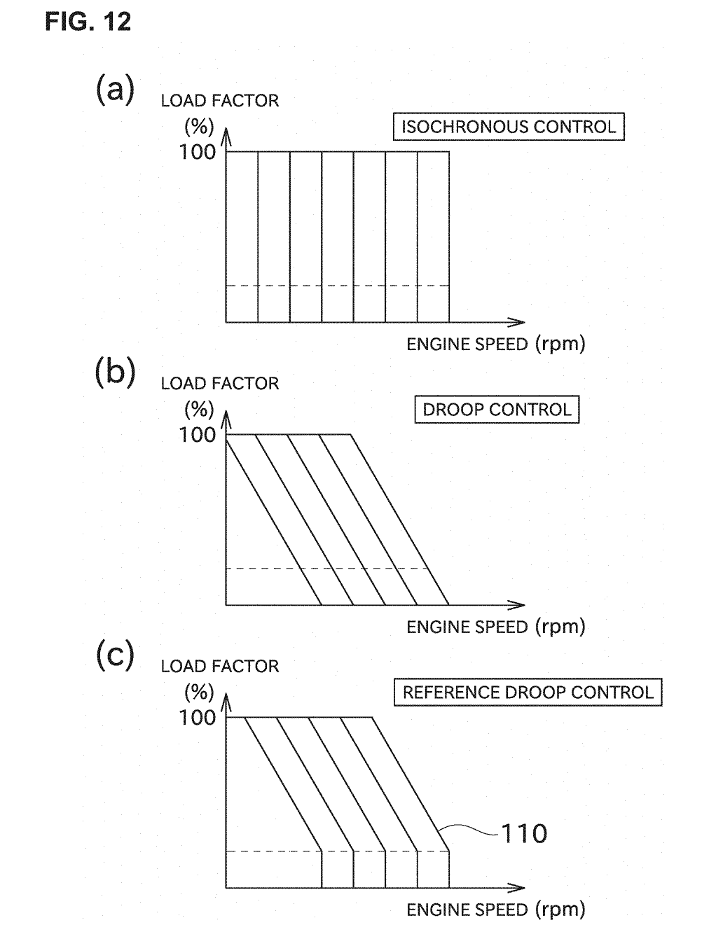

Since the isochronous control and the droop control have been well-known as a method for controlling the engine speed, a detailed description is omitted. The isochronous control is to keep the engine speed constant regardless of variation of load. The droop control is to reduce the engine speed along with an increase in load. For the isochronous control and the droop control, FIG. 12 (a) and FIG. 12 (b) show the diagrams (torque diagrams) in which the horizontal axis represents an engine speed N (rpm), and the vertical axis represents a load factor P (%).

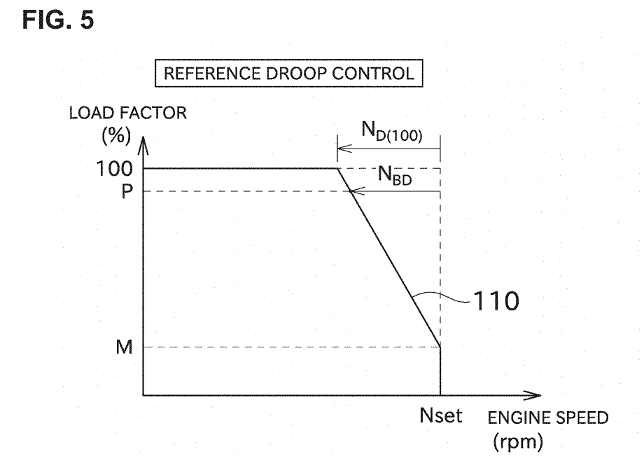

FIG. 5 and FIG. 12(c) are diagrams (torque diagrams) showing that, in the above-described reference droop control, the horizontal axis represents the engine speed N (rpm) and the vertical axis represents the load factor P (%). These diagrams have a portion where the constant engine speed is kept regardless of load, and a portion where the engine speed is reduced depending on an increase in load. In the following description, among the diagrams of the reference control shown in FIG. 5 and FIG. 12 (c), the portion where the engine speed is reduced depending on the increase in load may be referred to as a droop working line 110.

Although the diagram of FIG. 5 shows a limit of the engine speed N and the load factor P, there is a torque diagram that shows the parallel lines inside the diagram as shown in FIG. 12 (c) other than the diagram of FIG. 5.

Regarding the method for detecting the load factor P as the vertical axis of FIG. 5, in this embodiment, the amount of fuel injection is calculated by a period for a state that the injector solenoid valve 51 is opened and a pressure (pressure of fuel injection) of the common rail 23 detected by the fuel injection pressure sensor 43, and then the load factor P is calculated by using an appropriate map or the like based on the amount of fuel injection and the engine speed detected by the engine speed sensor 41. However, the method for detecting the load factor P is not limited to the above-described method. For example, in an engine that controls the amount of fuel injection by controlling a fuel metering rack of the fuel injection pump, an operation position of the fuel metering rack is detected by using an appropriate sensor, and then the load factor P may be calculated based on the detection result and the engine speed detected by the engine speed sensor 41. The load factor P may be calculated by using the map or the like based on the engine speed that is set based on the operation position of the accelerator sensor 42 and an actual engine speed detected by the engine speed sensor 41.

In this control, an engine speed correction amount (an engine speed reference reduction correction amount) NBD when the load factor P exceeds a droop load margin amount M(%) is NBD=ND(100)×(P−M)/(100−M), by using an engine speed reduction correction amount at a time of 100% of load factor as ND(100). This calculation is implemented by a reference droop control correction amount calculation unit 36 included in the ECU 30.

The engine speed reference reduction correction amount NBD obtained as above corresponds to the droop working line 110 of the reference droop control. The droop load margin amount M and the engine speed reduction correction amount ND(100) at a time of 100% of load factor are preset in the engine 1. These parameter M, ND(100) may be set for each engine target speed.

However, the control based on the regulation characteristic shown in FIG. 5 may lead to the insufficient power depending on applications used by the engine 1 and load characteristics, or may cause an increasing noise or the like due to the unsteady engine speed for variation of load.

In this respect, in this embodiment, the droop working line 110 having the regulation characteristic of FIG. 5 is adjusted in a convex direction or concave direction, so that the engine 1 can be controlled in accordance with the working line after adjustment.

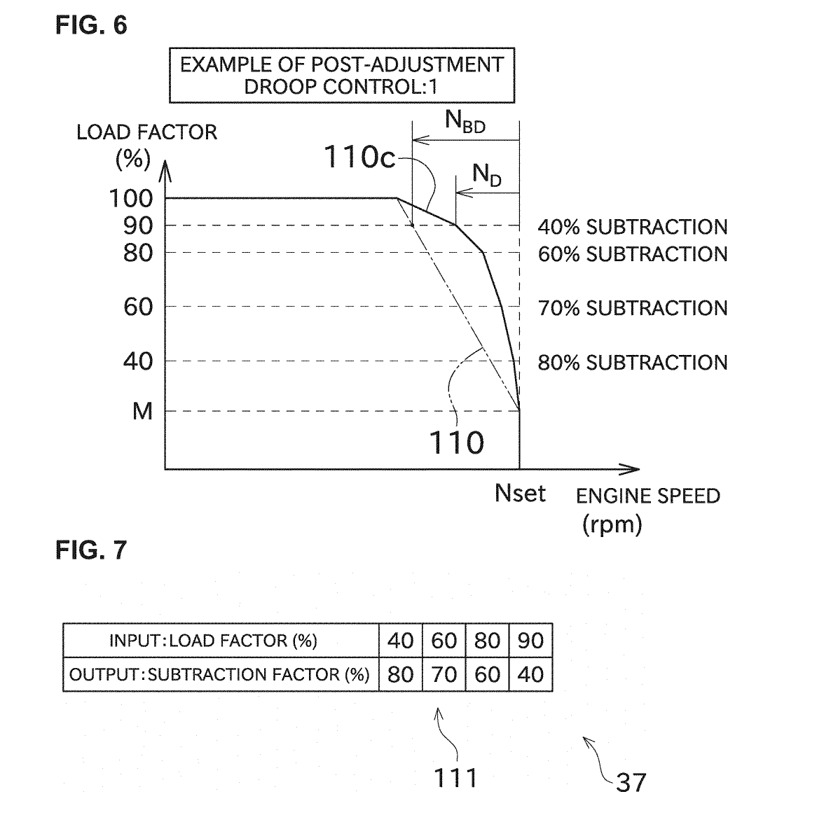

FIG. 6 shows an example of the regulation characteristic where the droop working line is adjusted in the convex direction.

In the following, a specific configuration for adjustment will be described. A correction amount adjustment map 111 shown in FIG. 7 is stored in a correction amount adjustment map storage unit 37 included in the ECU 30. The correction amount adjustment map 111 determines that the subtraction factor (the correction amount adjustment parameter) that subtracts the above-described engine speed reference reduction correction amount NBD varies in accordance with the load factor. A plurality of pairs of the load factor and the subtraction factor corresponding to the load factor is set in the correction amount adjustment map 111.

For example, when the load factor P is 90%, the above-described engine speed reference reduction correction amount is NBD (90). According to the correction amount adjustment map 111 of FIG. 7, the subtraction factor is 40% when the load factor P is 90%. Then, the actual engine speed reduction correction amount ND(90) is ND(90)=NBD(90)×(100−40)/100. This calculation is implemented by the post-adjustment correction amount calculation unit 38 included in the ECU 30. As such, the post-adjustment engine speed reduction correction amount ND is determined.

In the correction amount adjustment map storage unit 37, a pair of the load factor and the subtraction factor is stored in a tabular format. The subtraction factor for the load factor without setting in the table (the correction amount adjustment map 111) is calculated by linear interpolation. This can achieve the adjustment of the droop working line that is deformed into a polygonal line and convex line as shown in FIG. 6. Therefore, in the reference droop control shown in FIG. 5, the power may be sufficient by performing the control of the engine 1 in accordance with a post-adjustment droop working line 110c even when the power is insufficient during the work.

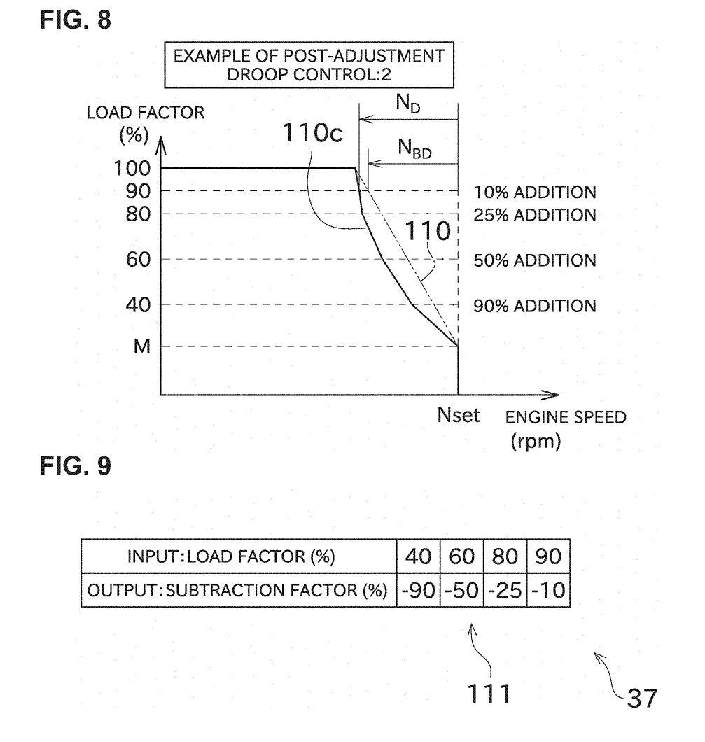

As above, although the droop working line 110 is adjusted so as to be deformed into the convex line, the droop working line 110 may be adjusted so as to be deformed into the concave line as shown in FIG. 8. In this case, even when the engine speed tends to be sensitively changed for the variation of load in the reference droop control of FIG. 5, too fast responsivity can be resolved by controlling the engine 1 in accordance with the post-adjustment droop working line 110c shown in FIG. 8. This concave adjustment can be achieved by setting a negative value as the subtraction factor of the correction amount adjustment map 111, as shown in FIG. 9.

As above, in the ECU 30 of this embodiment, the droop working line 110 of the conventional reference droop control (FIG. 5) can be adjusted in both convex direction and concave direction. Therefore, the droop working line 110c can be appropriately formed and then the control can be performed depending on the various applications, load characteristics and the like.

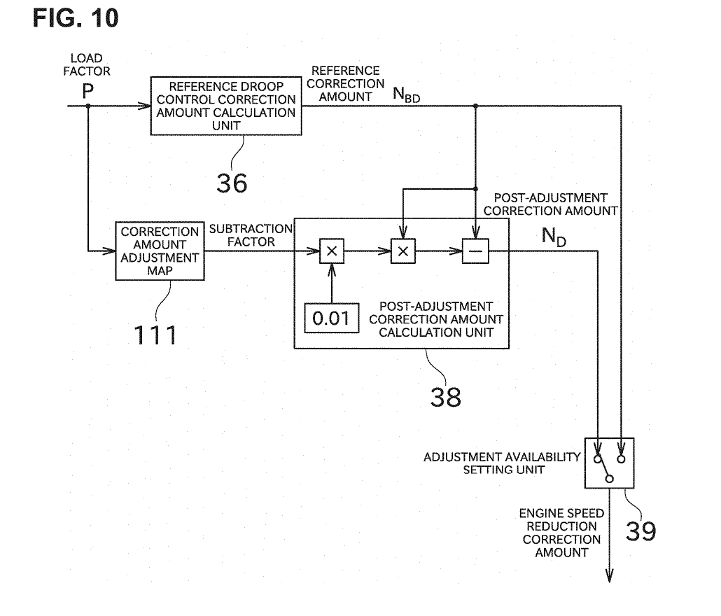

In the following, a signal flow in the above-described control will be described with reference to FIG. 10. FIG. 10 is a signal flow of the droop control in this embodiment.

The load factor P is obtained by using the above-described appropriate method. When it is determined that the load factor P exceeds the droop load margin amount M, the load factor P is inputted in the reference droop control correction amount calculation unit 36 and the correction amount adjustment map 111. The reference droop control correction amount calculation unit 36 calculates the engine speed reference reduction correction amount NBD based on the inputted load factor P. The obtained engine speed reference reduction correction amount NBD is outputted to the post-adjustment correction amount calculation unit 38 and the adjustment availability setting unit 39.

The load factor P is converted into the subtraction factor (in percent) based on the correction amount adjustment map 111. The subtraction factor is inputted in the post-adjustment correction amount calculation unit 38 and converted into a decimal by multiplying 0.01, and then multiplies the engine speed reference reduction correction amount NBD inputted from the post-adjustment correction amount calculation unit 38. This obtained result is subtracted from the engine speed reference reduction correction amount NBD. This can obtain the engine speed reduction correction amount ND as the correction amount after adjustment. The obtained engine speed reduction correction amount ND is outputted to the adjustment availability setting unit 39.

The adjustment availability setting unit 39 is configured to select the reference correction amount (the engine speed reference reduction correction amount NBD) or the post-adjustment correction amount (the engine speed reduction correction amount ND) for use, for example, based on the setting value given in the setting operation at a factory setting. The either selected one of two is used as the correction amount for reducing the engine speed.

In the ECU 30 of this embodiment, a plurality of kinds of correction amount adjustment map 111 can be preset. Specifically, both of the correction amount adjustment map 111 of FIG. 7 and the correction amount adjustment map 111 of FIG. 9 can be stored in the correction amount adjustment map storage unit 37 (the storage unit 32 of the ECU 30). Then, in an appropriate timing prior to working of the engine 1 (at a time of shipment of the engine), one of the plurality of kinds of correction amount adjustment map 111 is selected based on the possible application, the user's designation or the like. The information that identifies the selected correction amount adjustment map 111 is set in the ECU 30. The ECU 30 can be set by operating an appropriate setting computer electrically connected with the ECU 30. The ECU 30 calculates the engine speed reduction correction amount ND in accordance with the selected correction amount adjustment map 111 and accordingly controls the engine 1.

This can flexibly and easily set the working line of the regulation characteristics at a time of shipment of the engine 1 in view of various circumstances. This can provide the engine 1 capable of widely matching with the various needs.

Next, the control of the engine 1 concerning a fuel leakage by the ECU 30 of this embodiment will be described.

The ECU 30 of this embodiment is configured to perform either one of two controls (both isochronous control and droop control are acceptable) in view of characteristics required for the marine vessel, user's choice or the like, at a normal state that the fuel leakage or the like is not detected. The ECU 30 may be also configured to switch the controls in accordance with the user's setting and the like.

On the other hand, the ECU 30 of this embodiment is configured that the control mode is automatically switched to the reference droop control when the fuel leakage is detected.

As described above, in the reference droop control (FIG. 12(c)), when the load is increased over the predetermined value, the engine speed is accordingly reduced unlike the isochronous control (FIG. 12(a)). Therefore, an excessive increase in the output in a high load area can be avoided, which can suppress the useless consumption of fuel. In the reference droop control (FIG. 12(c)), the change of the engine speed when the load is considerably increased and decreased to some extent is small as compared with the droop control (FIG. 12(b)). Therefore, a sudden acceleration and deceleration of the engine speed along with the increase and decrease in load can be prevented, which can effectively save the amount of fuel consumption. As above, the reference droop control can be preferably used as a control mode for extending an engine operating time while saving the fuel at a time of occurring the abnormality of fuel.

As shown in FIG. 4, a fuel condition determination unit 45 provided in the engine 1 including the fuel injection pressure sensor 43 and a fuel amount detection sensor 44 detects a state of fuel.

The fuel abnormality determination unit 33 determines whether or not the abnormality of fuel occurs based on the pressure of fuel within the common rail 23 detected by the fuel injection pressure sensor 43. Specifically, the fuel abnormality determination unit 33 calculates a target pressure of the fuel based on an operation state (for example, the target engine speed and the like based on the depressed amount of an accelerator). Next, the fuel abnormality determination unit 33 compares the target pressure with the fuel pressure (detection pressure) within the common rail 23 actually detected by the fuel injection pressure sensor 43. Then, the fuel abnormality determination unit 33 determines that the fuel leakage occurs when the detection pressure is lower than the target pressure and the difference of pressure exceeds a predetermined threshold value.

When the fuel abnormality determination unit 33 determines that the fuel leakage occurs, the control unit 31 in the ECU 30 of this embodiment switches to the reference droop control and controls the engine 1. Accordingly, the reference droop control is performed when the fuel leakage occurs, which can save the amount of fuel consumption.

The ECU 30 of this embodiment has the fuel amount detection sensor 44, and thereby the optimal reference droop control can be performed for the engine 1 depending on the remaining amount of fuel. To be specific, the storage unit 32 included in the ECU 30 prestores a plurality of maps (the above-described correction amount maps) in accordance with the remaining amount of fuel. The correction amount maps show the correction amount of the engine speed of a portion where the engine speed is reduced in accordance with the increase and decrease in load in the torque diagram of the reference droop control shown in FIG. 12 (c). A plurality of correction amount maps are stored in the ECU 30 of this embodiment. This means that the reference droop control can be performed while changing a slope or the like of the droop working line 110 shown in FIG. 12 (c) in accordance with the remaining amount of fuel (for example, in stages). The ECU 30 controls the engine 1 based on the droop working line 110 according to the amount of fuel detected by the fuel amount detection sensor 44.

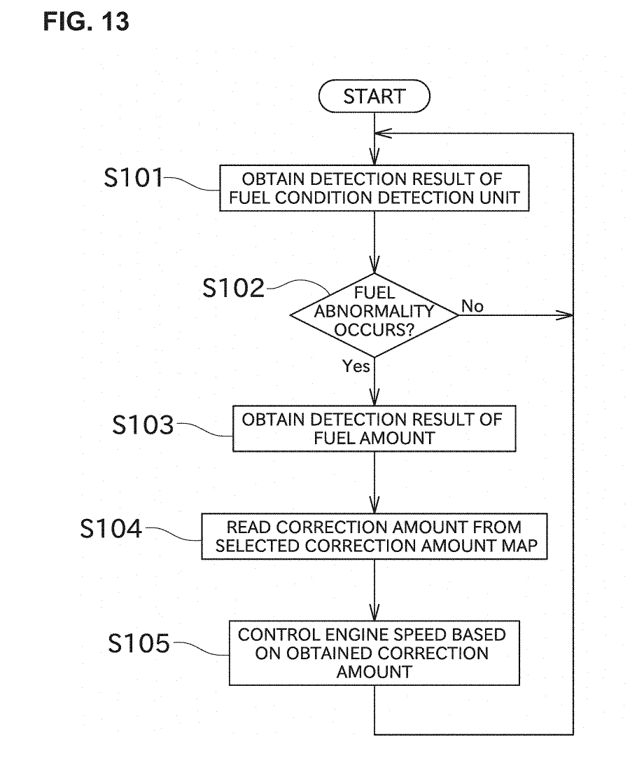

Next, the control of the engine 1 performed in the ECU 30 of this embodiment will be described with reference to a flowchart in FIG. 13 showing the control of abnormality of fuel.

The ECU 30 obtains the detection result of the pressure of fuel within the common rail 23 from the fuel condition determination unit 45 (step S101). Then, the fuel abnormality determination unit 33 compares the target pressure of fuel calculated based on a status of the engine 1 with an actual pressure (detected pressure) of fuel detected by the fuel injection pressure sensor 43 (step S102). If the detected pressure is almost same as the target pressure, it is determined that the fuel leakage does not occur, which allows to return to the step S101.

In the step S102, when the above-described detected pressure is smaller than the target pressure, and when the difference between the detected pressure and the target pressure exceeds the predetermined threshold value, it is determined that the abnormality such as fuel leakage occurs. In the step S102, when it is determined that the abnormality of fuel occurs, the control unit 31 obtains the remaining amount of fuel within the fuel tank 20 from the fuel amount detection sensor 44 (step S103). Next, the control unit 31 selects one correction amount map in accordance with the remaining amount of fuel from the plurality of correction amount maps, and the correction amount of engine speed is read out from the selected correction amount map (step S104). The ECU 30 performs the reference droop control based on the obtained correction amount (step S105).

In the above-described steps, when the abnormality such as fuel leakage is detected, the ECU 30 controls the engine 1 by performing the reference droop control having the appropriate regulation characteristic, which can extend the operation time of the engine 1 while saving the fuel. This means that the operation of the engine 1 can be kept as far as possible under an abnormal situation such as fuel leakage. Therefore, it is extremely useful to increase the possibility of port call when the fuel leakage occurs in the engine at an offshore marine vessel, for example.

As described above, the ECU 30 provided with the engine 1 of this embodiment keeps a constant engine speed regardless of variation of load factor P when the load factor P is equal to or less than the droop load margin amount M, whereas the ECU 30 performs the engine control for decreasing and correcting the engine speed in accordance with an increase in the load factor P when the load factor P exceeds the droop load margin amount M. The ECU 30 includes the reference droop control correction amount calculation unit 36, the correction amount adjustment map storage unit 37, and the post-adjustment correction amount calculation unit 38. The reference droop control correction amount calculation unit 36 obtains the engine speed reference reduction correction amount NBD that is increased at a constant rate in accordance with the increased amount of load factor from the droop load margin amount M. The correction amount adjustment map storage unit 37 stores the subtraction factor that changes in accordance with the load factor P as the correction amount adjustment map 111. When the load factor P exceeds the droop load margin amount M, the post-adjustment correction amount calculation unit 38 calculates the engine speed reduction correction amount ND that is the amount for decreasing and correcting the engine speed in accordance with the increased amount of the load factor P based on the engine speed reference reduction correction amount NBD and the subtraction factor.

That is, merely performing the reference droop control shown in FIG. 5 may lead to the insufficient output or too fast load responsivity, depending on the applications and load characteristics of engine 1. Here, as described above, the correction amount of the engine speed is adjusted by the correction amount adjustment map and the post-adjustment correction amount calculation unit 38, on the basis of the droop working line 110 of the reference droop line. This allows regulation characteristic of the engine 1 to be flexibly matched with applications, load characteristics, user's choice or the like.

In the ECU 30 of this embodiment, the post-adjustment correction amount calculation unit 38 calculates, based on the subtraction factor, the engine speed reduction correction amount ND by adjusting so as to be smaller than the engine speed reference reduction correction amount NBD if the subtraction factor is positive, or by adjusting so as to be larger than the engine speed reference reduction correction amount NBD if the subtraction factor is negative.

Accordingly, the reduction of engine speed is suppressed if it is assumed that the reference droop control is insufficient for the engine 1. By contrast, the engine speed can be adjusted so as to further promote the reduction if it is assumed that the reference droop control leads to too fast load responsivity. Therefore, the regulation characteristic of the engine 1 can be easily and flexibly matched with the wide range of applications and the like.

In the ECU 30 of this embodiment, the post-adjustment correction amount calculation unit 38 calculates the engine speed reduction correction amount ND by multiplying the ratio based on the subtraction factor by the engine speed reference reduction correction amount NBD.

Accordingly, the correction amount can be adjusted by the ratio calculation. This can adjust the engine speed reduction correction amount in response to the wide range of situations with a simple calculation.

In the ECU 30 of this embodiment, the correction amount adjustment map storage unit 37 stores the subtraction factor (correction amount adjustment map 111) in a tabular format. The post-adjustment correction amount calculation unit 38 is configured to obtain the subtraction factor corresponding to the load factor P by interpolation calculation between the values stored in the table.

Accordingly, the subtraction factor can be appropriately calculated in accordance with the load factor P while reducing the storage capacity for storing the subtraction factor.

In the ECU 30 of this embodiment, the correction amount adjustment map storage unit 37 stores the plurality of kinds of subtraction factors (correction amount adjustment map 111). The post-adjustment correction amount calculation unit 38 calculates the engine speed reduction correction amount ND based on one subtraction factor (correction amount adjustment map 111) selected from the plurality of kinds of subtraction factors (correction amount adjustment map 111) prior to the engine operation.

This allows the regulation characteristic of the engine 1 to be easily and flexibly matched with applications, load characteristics, user's choice and the like.

The ECU 30 of this embodiment can perform at least one of a plurality of engine controls including the isochronous control that keeps a constant engine speed regardless of variation of load, the droop control that reduces the engine speed along with the increase in load, and the reference droop control that keeps a constant engine speed regardless of variation of load when the load is equal to or less than a predetermined load, and reduces the engine speed along with the increase in load when the load exceeds the predetermined load. The ECU 30 includes the fuel abnormality determination unit 33 and the control unit 31. The fuel abnormality determination unit 33 determines whether or not the abnormality of fuel occurs based on the detection result of the fuel condition determination unit 45 that detects the fuel condition. The control unit 31 performs one control (the reference droop control) of the plurality of engine controls when the fuel abnormality determination unit determines that the abnormality of fuel occurs.

Accordingly, when the abnormality of fuel such as fuel leakage is detected, the control appropriately selected is performed, which can extend the operation time of the engine 1 while saving the fuel.

In the ECU 30 of this embodiment, the fuel condition determination unit 45 includes the fuel injection pressure sensor 43 that detects the pressure of fuel. The above-described fuel abnormality determination unit 33 determines whether or not the fuel leakage occurs, based on the detection result of the fuel injection pressure sensor 43.

Accordingly, since the fuel condition of the engine 1 can be determined from the viewpoint of the pressure, the abnormality such as fuel leakage can be early and appropriately detected.

In the ECU 30 of this embodiment, the control unit 31 controls the engine 1 by performing the reference droop control when the fuel abnormality determination unit 33 determines that the abnormality of fuel occurs.

Accordingly, when the abnormality of fuel such as fuel leakage is detected, the control is automatically shifted to the reference droop control suitable for saving the fuel. This can effectively save the fuel.

In the engine 1 of this embodiment, the fuel condition determination unit 45 includes the fuel amount detection sensor 44 that detects the fuel amount within the fuel tank 20. The control unit 31 controls the engine 1 in accordance with the fuel amount within the fuel tank 20 when the fuel abnormality determination unit 33 determines that the abnormality of fuel occurs.

Accordingly, the engine is controlled in accordance with the remaining amount of fuel, which can further suppress the useless fuel consumption and extend the operation time of the engine.

The ECU 30 of this embodiment includes the storage unit 32 for storing the parameter concerning the control of the engine 1. The control unit 31 controls the engine 1 by performing the reference droop control when the fuel abnormality determination unit 33 determines that the abnormality of fuel occurs. In the reference droop control when the fuel abnormality determination unit 33 determines that the abnormality of fuel occurs, the storage unit 32 prestores, depending on the fuel amount within the fuel tank 20, the plurality of correction tables concerning the engine speed correction amount that reduces the engine speed in accordance with the increase in load when the load exceeds the predetermined load. The control unit 31 controls the engine 1 by selecting one correction table from the plurality of correction tables based on the fuel amount detected by the fuel amount detection sensor 44.

Accordingly, the fuel can be effectively saved by flexibly and easily changing the control characteristics of the engine 1 depending on the remaining amount of fuel.

The ECU 30 of this embodiment includes the fuel condition output unit 34 that outputs the fuel condition detected by the fuel condition determination unit 45 from the ECU 30 to outside.

This can effectively utilize information concerning the fuel shortage, fuel leakage and the like. For example, the information is displayed on the display 70 to inform the user, which enables the user to appropriately recognize the status.

Although a preferred embodiment of the present invention and a variation thereof have been described above, the above-described configuration can be modified, for example, as follows.

In the above-described embodiment, the engine 1 is used for the vessel, however, the usage of the engine 1 is not limited to this. For example, the engine 1 can be applied to the wide range of applications such as construction machinery, agricultural machinery and the like. The present invention can be applied to a natural aspiration engine for air intake without the turbocharger 11.

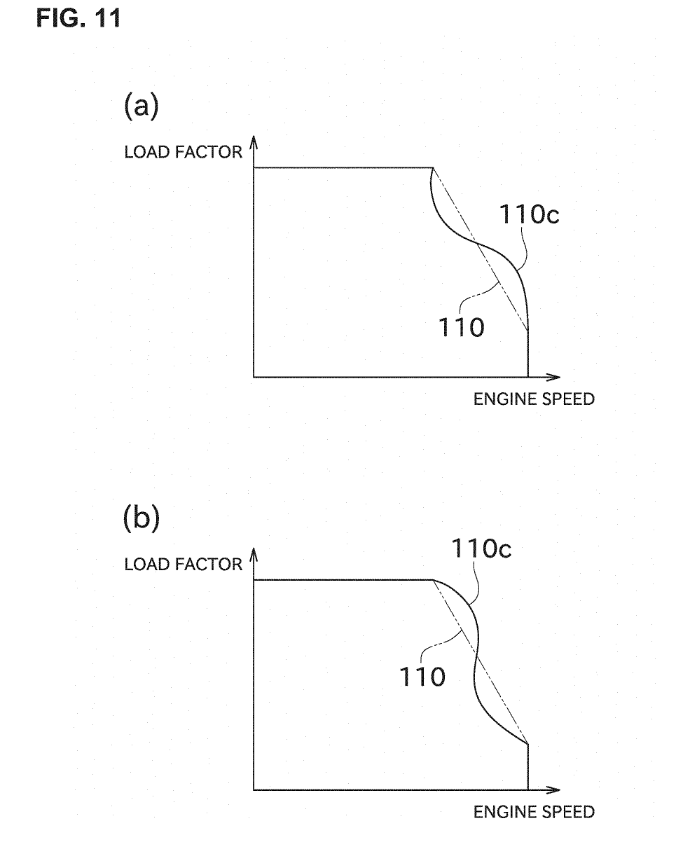

Any method for defining the correction amount adjustment map 111 may be adoptable. For example, the correction amount adjustment map 111 may be set such that the droop working line 110c is formed into S-shape shown in FIG. 11.

The number of the correction amount adjustment map 111 for storing is not limited to the above-described two kinds. Three kinds or more of maps can be stored. Only one kind of correction amount adjustment map 111 may be configured to be stored.

In the above-described embodiment, the subtraction factor is set by percent in the correction amount adjustment map 111. However, a setting format is not limited to this. For example, instead of the subtraction factor, the multiplication factor can be set. In this case, 0.2 is set as the multiplication factor instead of setting 80 as the subtraction factor. 1.9 is set as the multiplication factor instead of setting −90 as the subtraction factor.

The ECU of this embodiment is configured to automatically switch to the reference droop control when the abnormality such as fuel leakage occurs. However, the user can determine whether or not the mode switching is performed, by using the operation unit (for example, a switch or the like).

The threshold value concerning the above-described pressure difference for use in the determination of the fuel leakage can be defined by a serviceman or the like. In this case, the sensitivity of the determination of the fuel leakage performed by the fuel abnormality determination unit 33 can be adjusted.

In the above-described embodiment, the fuel abnormality determination unit 33 determines whether or not the fuel leakage occurs based on the pressure difference of the target pressure of the fuel pressure and the fuel pressure within the common rail 23. However, instead of this, other means may determine the fuel leakage. For example, it can be considered that the fuel amount in which the engine is consumed in each of operating areas is compared with the fuel amount supplied from the fuel pump 22, which can determine that the fuel leakage occurs when the difference of the fuel amount exceeds the predetermined threshold value.

The control by the ECU 30 is not limited to the reference droop control when the abnormality such as fuel leakage occurs. The ECU 30 may perform the other controls suitable for saving the fuel. For example, the isochronous control may be performed at a normal state, whereas the droop control may be performed when the abnormality of fuel occurs (in this state, the ECU 30 may be configured to have no control mode of the reference droop control). The droop control that is different from the isochronous control reduces the engine speed in accordance with an increase in load. This can avoid an excessive increase in the output in a high load area. In this respect, it can be considered that the droop control is suitable for the fuel saving.

The state other than the fuel leakage described in the above-described embodiment, such as a state where the fuel is running short, may be detected as the abnormality of fuel. In such a case, a special control such as the reference droop control may be performed for saving the fuel.

### DESCRIPTION OF THE REFERENCE NUMERALS

1 engine
30 ECU (engine control unit)
31control unit
32 storage unit
36 reference droop control correction amount calculation unit (engine speed reference reduction correction amount acquisition unit)
37 correction amount adjustment map storage unit (correction amount adjustment parameter storage unit)
38 post-adjustment correction amount calculation unit (correction amount adjustment parameter storage unit)
110 droop working line of reference droop control
110c post-adjustment droop working line
111 correction amount adjustment map
NBD engine speed reference reduction correction amount
ND engine speed reduction correction amount

What is claimed is:

1. An engine control unit that keeps a constant engine speed regardless of variation of load when a load is equal to or less than a predetermined load, the engine control unit that reduces and corrects the engine speed along with an increase in load when the load exceeds the predetermined load comprising:
an engine speed reference reduction correction amount acquisition unit for obtaining an engine speed reference reduction correction amount that is increased at a constant rate depending on the amount of load increased from the predetermined load;
a correction amount adjustment parameter storage unit for storing a correction amount adjustment parameter that is changed depending on the load; and
an engine speed reduction correction amount calculation unit for calculating an engine speed reduction correction amount that is the amount of correction by decreasing the engine speed along with an increase in load exceeded from the load based on the engine speed reference reduction correction amount and the correction amount adjustment parameter.

2. The engine control unit according to claim 1, wherein
the engine speed reduction correction amount calculation unit calculates the engine speed reduction correction amount by adjusting the engine speed reduction correction amount so as to be larger or smaller than the engine speed reference reduction correction amount based on the correction amount adjustment parameter.

3. The engine control unit according to claim 2, wherein
the engine speed reduction correction amount calculation unit calculates the engine speed reduction correction amount by multiplying the ratio based on the correction amount adjustment parameter by the engine speed reference reduction correction amount.

4. The engine control unit according to claim 1, wherein
the correction amount adjustment parameter storage unit stores the correction amount adjustment parameter in a tabular format,
the engine speed reduction correction amount calculation unit is configured to obtain the correction amount adjustment parameter depending on the load by interpolation calculation between values stored in the table.

5. The engine control unit according to claim 1, wherein
the correction amount adjustment parameter storage unit stores a plurality of kinds of correction amount adjustment parameters,
the engine speed reduction correction amount calculation unit calculates the engine speed reduction correction amount based on one correction amount adjustment parameter that is selected from the plurality of kinds of correction amount adjustment parameters prior to an operation of the engine.

6. An engine comprising:
the engine control unit according to claim 1.
